(19) United States
(12) Patent Application Publication
(10) Pub. No.: US 2018/0339763 A1
(43) Pub. Date: Nov. 29, 2018

(54) LINEAR SENSOR FEEL MODULE FOR AIRCRAFT CONTROLS

(71) Applicant: Sikorsky Aircraft Corporation, Stratford, CT (US)

(72) Inventors: Christopher Joseph Marini, Cheshire, CT (US); Paul Michael Shields, New Haven, CT (US)

(21) Appl. No.: 15/901,582

(22) Filed: Feb. 21, 2018

Related U.S. Application Data
(60) Provisional application No. 62/511,045, filed on May 25, 2017.

(51) Int. Cl. B64C 13/50; B64C 13/40; B64C 13/04

(52) U.S. Cl. CPC B64C 13/503; B64C 13/044; B64C 13/40

(57) ABSTRACT

A linear sensor module includes a fixed housing and a piston movable within the housing in response to an input. At least one biasing mechanism is operably coupled to the piston. A fly-by-wire input is associated with the piston and is operable to communicate the input to a control system.

### CROSS-REFERENCE TO RELATED APPLICATIONS

This application claims the benefit of U.S. Provisional Application Ser. No. 62/511,045, filed May 25, 2017, which is incorporated herein by reference in its entirety.

### STATEMENT OF FEDERAL SUPPORT

This invention was made with Government support under HR0011-15-9-0004 awarded by the Defense Advanced Research Projects Agency (DARPA). The Government has certain rights in the invention.

### BACKGROUND

Exemplary embodiments of the disclosure generally relate to a rotary wing aircraft, and more particularly, to a primary flight control input displacement for a Fly-By-Wire (FBW) flight control system.

The majority of helicopters utilize main rotor assembly and an anti-torque tail rotor assembly. The tail rotor assembly has proven to be efficient and reliable for providing lateral thrust to counteract induced torque generated by the main rotor assembly and to provide yaw directional control of the helicopter in hover, transitional, low, and high speed flight regimes.

Control of the anti-torque tail rotor assembly is conventionally achieved through a relatively large pedal system which provides control proportional to the pedal displacement. The pilot must typically constantly manipulate the pedals to coordinate changes in power, bank angle, or speed. This may result in a significant pilot workload.

Fly-By-Wire (FBW) flight control systems are becoming more common because they provide substantial improvements in reducing the pilot's workload. Although significant benefits are realized with FBW flight control systems, conventional relatively large displacement FBW pedal systems have not utilized FBW control systems to full advantage.

### BRIEF DESCRIPTION

According to an embodiment, a linear sensor module includes a fixed housing and a piston movable within the housing in response to an input. At least one biasing mechanism is operably coupled to the piston. A fly-by-wire input is associated with the piston and is operable to communicate the input to a control system.

In addition to one or more of the features described above, or as an alternative, in further embodiments the piston is movable along an axis within the housing.

In addition to one or more of the features described above, or as an alternative, in further embodiments the fly-by-wire input includes a variable differential transformer.

In addition to one or more of the features described above, or as an alternative, in further embodiments the fly-by-wire input is configured to monitor a distance and a direction of movement of the piston within the housing.

In addition to one or more of the features described above, or as an alternative, in further embodiments the fly-by-wire input is configured to monitor a final position of the piston within the housing in response to the input.

In addition to one or more of the features described above, or as an alternative, in further embodiments the at least one biasing mechanism is connected to an end of the housing and the piston.

In addition to one or more of the features described above, or as an alternative, in further embodiments comprising a damping mechanism arranged within the hollow interior of the housing, the damping mechanism being associated with at least one of the piston and the at least one biasing mechanism.

According to another embodiment, a rotary wing aircraft includes at least one controllable component and a fly-by-wire flight control system in communication with the at least one controllable component. A flight control is arranged in communication with the fly-by-wire flight control system to control the at least one controllable component. The flight control includes a linear sensor module having a fly-by-wire input operable to communicate a pilot input provided to the flight control to the fly-by-wire flight control system.

In addition to one or more of the features described above, or as an alternative, in further embodiments the linear sensor module applies a centering force to the flight control.

In addition to one or more of the features described above, or as an alternative, in further embodiments the fly-by-wire input includes a variable displacement transformer.

In addition to one or more of the features described above, or as an alternative, in further embodiments the linear sensor module is passive.

In addition to one or more of the features described above, or as an alternative, in further embodiments the linear sensor module is active.

In addition to one or more of the features described above, or as an alternative, in further embodiments the linear sensor module further comprises: a housing fixed relative to the flight control; a piston movable within the housing in response to the pilot input; and at least one biasing mechanism operably coupled to the piston.

In addition to one or more of the features described above, or as an alternative, in further embodiments the fly-by-wire input is operably coupled to the piston.

In addition to one or more of the features described above, or as an alternative, in further embodiments the linear sensor module further comprises a damping mechanism associated with at least one of the piston and the at least one biasing mechanism.

In addition to one or more of the features described above, or as an alternative, in further embodiments the flight control is a pedal system.

In addition to one or more of the features described above, or as an alternative, in further embodiments the pedal system further comprises a first pedal and a second pedal linked to a support structure through a crank assembly, the crank assembly being pivotable relative to the support structure about a support axis.

In addition to one or more of the features described above, or as an alternative, in further embodiments the piston is movable in a first direction within the housing in response to application of a force to the port pedal, and the piston is movable in a second, opposite direction within the housing in response to application of a force to the starboard pedal.

In addition to one or more of the features described above, or as an alternative, in further embodiments comprising an actuator arm connected to the crank assembly, the piston being operably coupled to the crank assembly via the actuator arm.

In addition to one or more of the features described above, or as an alternative, in further embodiments the flight control is a primary flight control operable to control one of yaw, roll, and pitch of the rotary wing aircraft.

### BRIEF DESCRIPTION OF THE DRAWINGS

The subject matter is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a general perspective view of an example of a rotary wing aircraft;

FIG. 2 is a perspective view of a fly-by-wire control system according to an embodiment;

FIG. 3 is a perspective view of a pedal system for use with the fly-by-wire control system of FIG. 2 according to an embodiment; and

FIG. 4 is a cross-sectional view of a linear sensor module for use with the pedal system according to an embodiment; and

FIG. 5 is a cross-sectional view of an active linear sensor module for use with the pedal system according to an embodiment.

The detailed description explains embodiments of the disclosure, together with advantages and features, by way of example with reference to the drawings.

### DETAILED DESCRIPTION

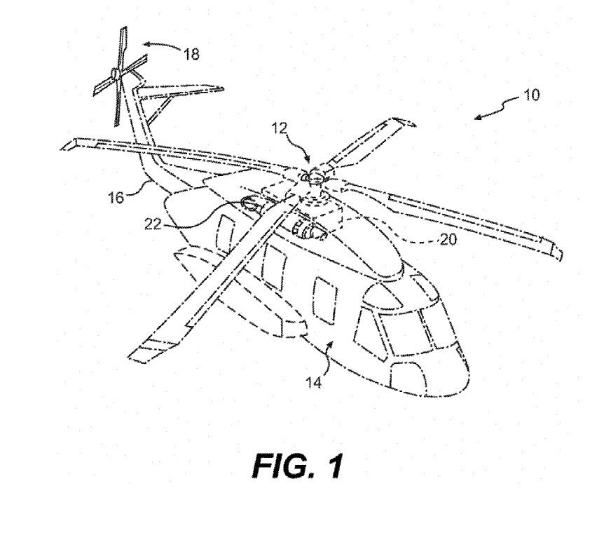

FIG. 1 schematically illustrates an example of a rotary wing aircraft 10, such as a helicopter for example, having a main rotor assembly 12. The rotary wing aircraft 10 includes an airframe having an extending tail which mounts an anti-torque tail rotor system 18. The main rotor assembly 12 and the anti-torque tail rotor system 18 are driven through a transmission, illustrated schematically at 20, by one or more engines, illustrated schematically at 22. Although a particular rotary wing aircraft configuration is illustrated and described in the disclosed embodiment, other configurations and/or machines, such as a high speed compound rotary wing aircraft with supplemental translational thrust systems, a dual contra-rotating, coaxial rotor system aircraft, and a turbo-prop, tilt-rotor or tilt-wing aircraft for example, will also benefit from the present disclosure.

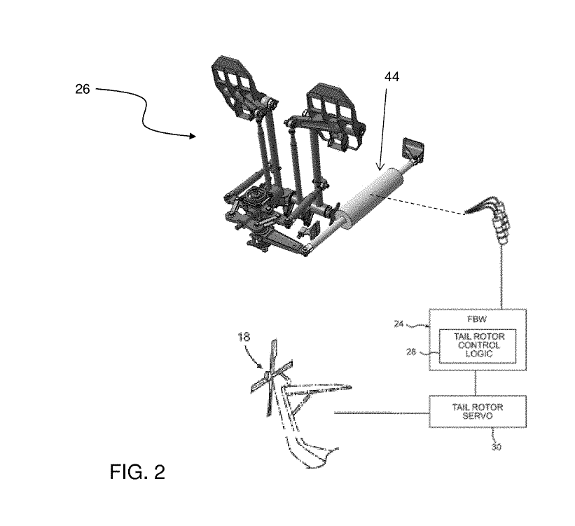

With reference now to FIG. 2, the anti-torque tail rotor system 18 is driven by an aircraft flight control system 24. In an embodiment, the aircraft flight control system 24 is a fly-by-wire (FBW) flight control system that utilizes signals to convey pilot commands to one or more corresponding flight control servos coupled to a movable surface or component of the aircraft 10. In a FBW flight control system, a pilot provides an input through FBW tail rotor control logic to control the anti-torque tail rotor system 18. In an embodiment, the FBW flight control system 24 requires a control input only when a change in the yaw axis state is demanded. That is, the FBW control system 24 may be described as a “command response hold system.”

The pilot's input is provided to the FBW flight control system 24 through an interface such as a pedal system 26. Since the anti-torque tail rotor system 18 is controlled through the FBW flight control system 24, the pedal system 26 need not be mechanically linked to the anti-torque tail rotor system 18. The pilot's input is communicated through the FBW yaw flight control logic 28 to drive, for example only, a tail rotor drive servo 30 which controls the pitch of the anti-torque tail rotor system 18. The FBW yaw flight control logic 28 typically utilizes aircraft rate and attitude response feedback directly to modify the pilot's input to yaw the aircraft 10 at a commanded rate and actively control the aircraft's response. As generally understood, FBW flight control systems may provide feedback mechanisms utilizing linear control system logic, such as proportional, integral, or derivative (PID) paths to achieve a desired response and the compensate for undesired destabilization forces acting on the aircraft in the particular axis. It should be understood that the FBW control logic theory may be provided to multiple flight control systems.

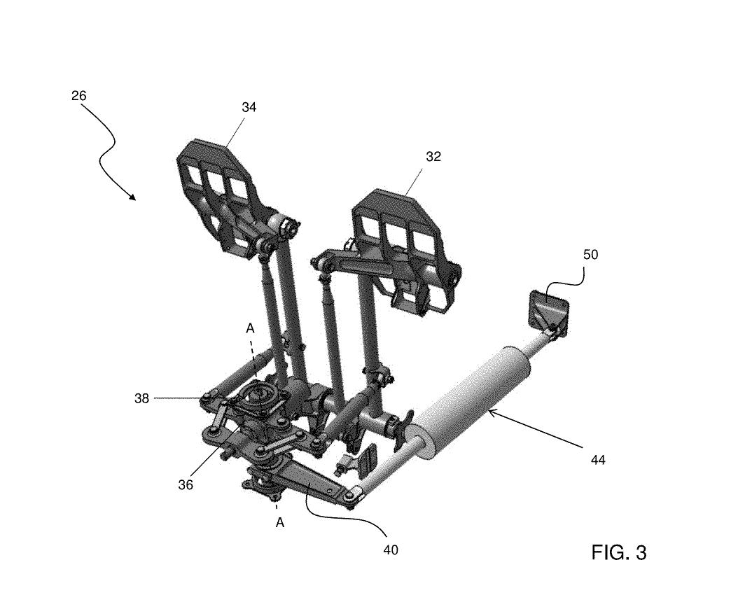

Referring now to FIG. 3, an example of a yaw pedal system 26 configured for use with a FBW flight control system 24 is illustrated. The pedal system 26 generally includes a relatively short travel port pedal 32 and a starboard pedal 34 which are linked to a support structure 36 through a crank assembly 38. Pressure on the port pedal 32 rotates the crank assembly 38 about a support axis A in a first direction and translates the starboard pedal 34 toward the pilot. Similarly, pressure applied to the starboard pedal 34 rotates the crank assembly 38 about a support axis A in an opposite direction and translates the port pedal 32 toward the pilot.

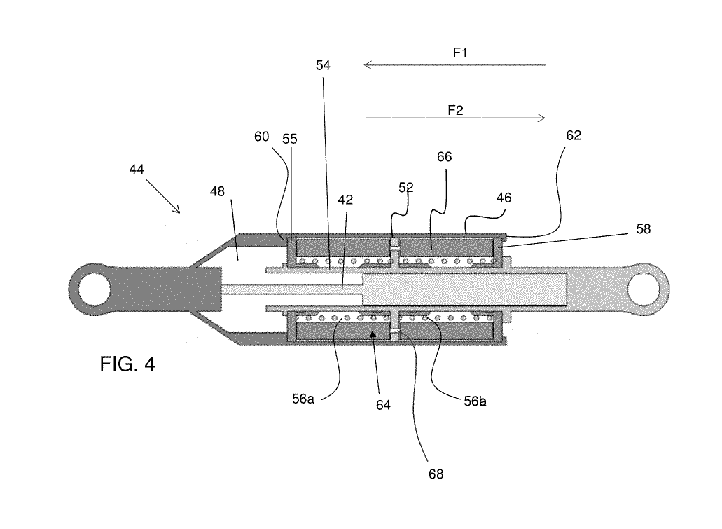

An output arm 40 is mounted to the crank assembly 38 for rotation about axis A therewith. The actuator arm 40 mechanically communicates motion of the pedals 32, 34 to the FBW control system 24 via a fly-by-wire input 42 (see FIGS. 4A and 4B). In the illustrated, non-limiting embodiment, the fly-by-wire input 42 includes a variable differential transformer associated with a linear sensor module 44.

An example of a linear sensor module 44 is shown in more detail in FIG. 4. The linear sensor module 44 includes a generally cylindrical housing 46 having a substantially hollow interior 48. The housing 46 is fixed relative to the yaw pedal system 26. In an embodiment, the housing 46 is fixed directly to a stationary portion of the pedal system 26, or alternatively, to an adjacent surface within the cockpit, such as an airframe bracket 50 shown in FIG. 3. A piston 52 is movably mounted within the hollow interior 48 of the housing 46. The piston 52 is operably coupled via a shaft 54 to output arm 40 and the crank assembly 38. Rotation of the crank assembly 38 in response to application of a force to one of the pedals 32, 34 results in a corresponding linear movement of the piston 52 within the housing 46. In the illustrated, non-limiting embodiment, the fly-by-wire input 42, such as the variable differential transformer for example, is mounted to the piston 52, such as concentrically within an opening formed in the shaft 54 for example, to sense the movement of the piston 52 indicative of a pilot's command input to the pedal system 26.

Mounted concentrically with and adjacent a first end of the shaft 54 is a first spring tensioning plate 55. Similarly, mounted adjacent a portion of the housing adjacent an end of the housing is a second, spring tensioning plate 58. Movement of the first spring tensioning plate 55 in a first direction, indicated by arrow F1, is restricted by engagement with a shoulder or bore 60 formed in the housing 46. Similarly, movement of the second spring tensioning plate 58 in a second direction, indicated by arrow F2, is restricted by engagement with a shoulder of bore 62 formed in the housing 46.

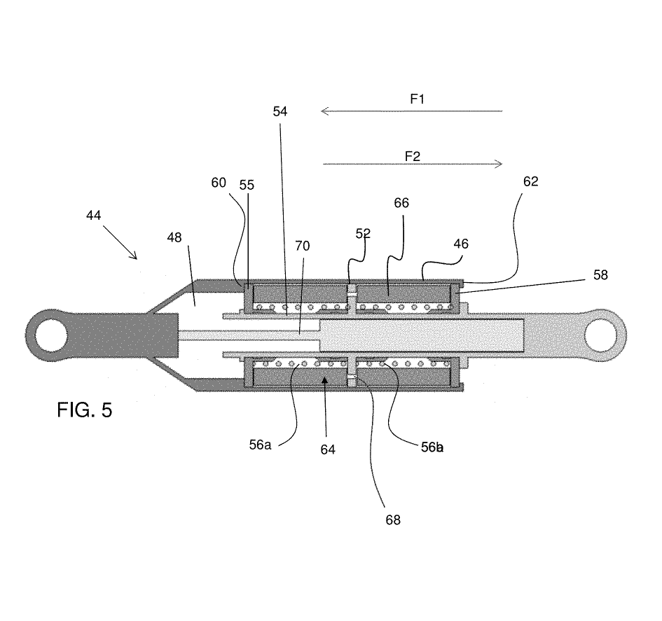

At least one biasing mechanism 56, such as a coil spring for example, is positioned within the hollow interior 48 of the housing 46. The at least one biasing mechanism 56 is configured to cooperate with the piston 52 to return the piston 52 to a neutral or zero load position after the piston 52 is moved in response to receipt of a command. In the illustrated non-limiting embodiment, as shown in FIGS. 4 and 5, the at least one biasing mechanism 56 includes a first biasing mechanism 56a arranged between the first spring tensioning plate 55 of the piston 52 and a second biasing mechanism 56b arranged between the piston 52 and the second spring tensioning plate 58. The first biasing mechanism 56a is configured to deflect in response to movement of the piston 52 in a first direction and the second biasing mechanism 56b is configured to deflect in response to movement of the piston 52 in the second, opposite direction. In such embodiments, the biasing mechanisms 56a, 56b may be substantially identical, or may have one or more varying characteristics, such as length, diameter, and spring rate for example.

The linear sensor module 44 may additionally include a damping mechanism 64 for regulating the speed of the piston 52 and/or at the least one biasing mechanism 56 between the zero load position and a commanded input position. For example, in an embodiment, the housing 46 may be filled with a damping fluid 66. The piston 52 may have one or more holes 68 formed therein such that the portion of the housing 46 between the piston 52 and the first spring tensioning plate 55 and the portion of the housing 46 between the piston 52 and the second spring tensioning plate 58 are in fluid communication. The viscosity of the damping medium 66 creates a drag on the piston 52 as it moves there through. Accordingly, the damping forces of the fluid acting on the piston 52 will depend in part on the speed of the movement of the piston 52. In another embodiment, the damping mechanism 64 may be a self-contained damper that is operably coupled to the spring 56 and/or the piston 52 to control movement thereof. The damping mechanism 64 illustrated and described herein is intended as an example only, and it should be understood that any suitable damping mechanism including both fluidic and electrical damping mechanisms are contemplated herein.

During operation of the aircraft 10, a pilot controls operation of the anti-torque tail rotor system 18 by providing an input to the pedal system 26. The pilot will apply a force to one of the port and starboard pedals 32, 34 causing the piston 52 to translate axially within the housing 46. When the shaft 54 is moved in a first direction indicated by arrow F1, the first biasing mechanism 56a is compressed between the piston 52 and the first spring tensioning plate 55. As the shaft and piston translate, the second tensioning plate 58 and the second biasing mechanism 56b are configured to move without any compression of the second biasing mechanism 56b. Accordingly, translation of the shaft 54 in the first direction compresses the first biasing mechanism 56a, but does not affect the second biasing mechanism 56b. Alternatively, when the shaft 54 is moved in a second, opposite direction indicated by arrow F2, the second biasing mechanism 56b is compressed between the piston 52 and the second spring tensioning plate 58. As the shaft 54 and piston 52 translate, the first tensioning plate 55 and the first biasing mechanism 56a are configured to move without compressing the first biasing mechanism 56a. Accordingly, translation of the shaft 54 in the second direction compresses the second biasing mechanism 56b, but does not affect the first biasing mechanism 56a.

The fly-by-wire input 42 coupled to the piston 52 will determine the distance and direction of movement of the piston 52 and/or a final position of the piston 52 driven by the movement of the pedals 32, 34. The input 42 is then supplied to the yaw flight control logic 28 where it is converted into a command and supplied to one or more servos 30 associated with the anti-torque tail rotor system 18. In embodiments where the linear sensor module 44 is passive, a pilot must maintain the control position to maintain a commanded state. It should be understood that although the linear sensor module 44 is described with respect to a pedal system 26, it should be understood that the module 44 may be adapted for use with any primary flight control input.

The linear sensor module 44 is illustrated and described herein as a passive system. However, embodiments where the linear sensor module 44 is configured as an active system are also contemplated herein. In such embodiments, the linear variable differential transformer is replaced by a linear actuator 70. The linear actuator may be operable to drive movement of the piston 52 in response to a signal received from the flight control system 24. In embodiments where the linear sensor module 44 is active, the pilot need not hold the pedals 32, 34 in a commanded position because the commanded state is maintained until another input is received. As a result, the biasing force of the at least one biasing mechanism 56 will act on the piston 52, thereby moving the piston 52, and the actuator arm 38 and pedals 32, 34 back to a zero load state. In an embodiment, the pedals 32, 34 are generally centered and/or aligned in the zero load state.

The linear sensor module 44 described herein is takes advantage of existing control system geometries by directly replacing the mechanical system pushrods associated with a pedal system 26. In addition, the linear sensor module 44 improves upon existing passive control devices by eliminating the gearing necessary to provide jam-proof operation and reduces the workload for the pilot.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. By way of example, aspects of the invention can be used with single rotor helicopters for the main and tail rotors, fixed wing aircraft propellers, drones, maritime propulsion systems, and wind/water turbine transmission. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

The invention claimed is:

1. A linear sensor module comprising:
a fixed housing;
a piston movable within the housing in response to an input;
at least one biasing mechanism operably coupled to the piston; and
a fly-by-wire input associated with the piston and operable to communicate the input to a control system.

2. The linear sensor module of claim 1, wherein the piston is movable along an axis within the housing.

3. The linear sensor module of claim 1, wherein the fly-by-wire input includes a variable differential transformer.

4. The linear sensor module of claim 1, wherein the fly-by-wire input is configured to monitor a distance and a direction of movement of the piston within the housing.

5. The linear sensor module of claim 1, wherein the fly-by-wire input is configured to monitor a final position of the piston within the housing in response to the input.

6. The linear sensor module of claim 1, wherein the at least one biasing mechanism is connected to an end of the housing and the piston.

7. The linear sensor module of claim 1, further comprising a damping mechanism arranged within the hollow interior of the housing, the damping mechanism being associated with at least one of the piston and the at least one biasing mechanism.

8. A rotary wing aircraft comprising:
at least one controllable component;
a fly-by-wire flight control system in communication with the at least one controllable element; and
a flight control in communication with the fly-by-wire flight control system to control the at least one controllable component, the flight control including a linear sensor module having a fly-by-wire input operable to communicate a pilot input provided to the flight control to the fly-by-wire flight control system.

9. The rotary wing aircraft of claim 8, wherein the linear sensor module applies a centering force to the flight control.

10. The rotary wing aircraft of claim 8, wherein the fly-by-wire input includes a variable displacement transformer.

11. The rotary wing aircraft of claim 8, wherein the linear sensor module is passive.

12. The rotary wing aircraft of claim 8, wherein the linear sensor module is active.

13. The rotary wing aircraft of claim 8, wherein the linear sensor module further comprises:
a housing fixed relative to the flight control;
a piston movable within the housing in response to the pilot input; and
at least one biasing mechanism operably coupled to the piston.

14. The rotary wing aircraft of claim 13, wherein the fly-by-wire input is operably coupled to the piston.

15. The rotary wing aircraft of claim 13, wherein the linear sensor module further comprises a damping mechanism associated with at least one of the piston and the at least one biasing mechanism.

16. The rotary wing aircraft of claim 13, wherein the flight control includes a pedal system.

17. The rotary wing aircraft of claim 16, wherein the pedal system further comprises a first pedal and a second pedal linked to a support structure through a crank assembly, the crank assembly being pivotable relative to the support structure about a support axis.

18. The rotary wing aircraft of claim 17, wherein the piston is movable in a first direction within the housing in response to application of a force to the first pedal, and the piston is movable in a second, opposite direction within the housing in response to application of a force to the second pedal.

19. The rotary wing aircraft of claim 18, further comprising an actuator arm connected to the crank assembly, the piston being operably coupled to the crank assembly via the actuator arm.

20. The rotary wing aircraft of claim 8, wherein the flight control is a primary flight control operable to control one of yaw, roll, and pitch of the rotary wing aircraft.
